(19) United States
(12) Patent Application Publication
(10) Pub. No.: US 2023/0408650 A1
(43) Pub. Date: Dec. 21, 2023

(54) LIDAR DEVICE

(71) Applicant: HL Klemove Corp., Incheon (KR)

(72) Inventor: Hak Gu HAN, Namyangju-si (KR)

(21) Appl. No.: 18/210,245

(22) Filed: Jun. 15, 2023

(30) Foreign Application Priority Data
Jun. 16, 2022 (KR) 10-2022-0073678
Feb. 8, 2023 (KR) 10-2023-0016782

(51) Int. Cl. G01S 7/481

(52) U.S. Cl. CPC G01S 7/4816; G01S 7/4815; G01S 7/4817

(57) ABSTRACT

A LIDAR device is disclosed. The LIDAR device according to an exemplary embodiment of the present disclosure may include an optical transmitter for transmitting laser light for detecting an external object; an optical receiver which is disposed to be spaced apart from one side of the optical transmitter and receives laser light that is reflected by the external object; and a scanner which is disposed between the optical transmitter and the optical receiver, reflects laser light that is transmitted by the optical transmitter to the outside, and reflects laser light that is reflected from the external object and returned to the optical receiver.

### CROSS-REFERENCE TO RELATED APPLICATION

This application claims priority to and the benefit of Korean Patent Applications No. 10-2022-0073678, filed on Jun. 16, 2022, and Korean Patent Application No. 10-2023-0016782, filed on Feb. 8, 2023, the disclosures of which are incorporated herein by reference in its entirety.

### BACKGROUND

### 1. Technical Field

The present disclosure relates to a LIDAR device, and more specifically to a LIDAR device for detecting an external object through laser light.

### 2. Discussion of Related Art

LIDAR (Light Detection And Ranging) is a radar system that measures the distance to an external object by using laser pulses. The LIDAR device measures the distance to a measurement object, the shape of the measurement object and the like by irradiating laser light to the surrounding area and measuring the time it takes for the laser light to be reflected by the measurement object and return.

In recent years, the LIDAR device has been utilized in various technology fields such as self-driving cars, mobile robots and the like. In this situation, the miniaturization of the LIDAR device is considered as an important task in order to secure the diversity of mounting positions of the LIDAR device. In particular, with regard to securing the diversity of mounting positions in the vehicle, the demand for reducing the height of the LIDAR device is increasing.

Meanwhile, in order to improve the detection performance, it is necessary to increase the output of a light source that is irradiated from the LIDAR device. However, in the case of a vertical-cavity surface-emitting laser (VCSEL), which is widely used as a laser light source of the conventional LIDAR device, tens to hundreds of channels must be configured along a vertical axis in order to increase the output. In addition, the optical reception unit also needs to configure and arrange channels corresponding to the optical transmission unit. As a result, there is a problem in that the difficulty of high-power design increases.
(Patent Document) Korean Registered Patent No. 2021-0101828 “LIGHT REFLECTION DEVICE AND LIDAR SCANNING SYSTEM HAVING THE SAME”, published on Aug. 19, 2021

### SUMMARY

The present disclosure has been devised to solve the problems of the related art described above, and an object of the present disclosure is to provide a LIDAR device having a high degree of freedom in the selection of a mounting position which is lower than the related art.

In addition, another object of the present disclosure is to provide a LIDAR device which is capable of easily and efficiently designing a high-power light source.

The objects of the present disclosure are not limited to the above-described objects, and other objects that are not mentioned will be able to be clearly understood by those skilled in the art to which the present disclosure pertains from the following description.

According to an aspect of the present disclosure, provided is a LIDAR device, including an optical transmitter for transmitting laser light for detecting an external object; an optical receiver which is disposed to be spaced apart from one side of the optical transmitter and receives laser light that is reflected by the external object; and a scanner which is disposed between the optical transmitter and the optical receiver, reflects laser light that is transmitted by the optical transmitter to the outside, and reflects laser light that is reflected from the external object and returned to the optical receiver.

In the LIDAR device according to an aspect of the present disclosure, the scanner may include a mirror having a plurality of reflective surfaces and an actuator for rotating the mirror such that the plurality of reflective surfaces rotate about a rotation axis.

In the LIDAR device according to an aspect of the present disclosure, the mirror may have 4 of the reflective surfaces.

In the LIDAR device according to an aspect of the present disclosure, each of the plurality of reflective surfaces may have a rectangular shape having the same size.

In the LIDAR device according to an aspect of the present disclosure, two adjacent reflective surfaces among the plurality of reflective surfaces may have a rectangular shape with different widths.

In the LIDAR device according to an aspect of the present disclosure, the optical transmitter may include a plurality of laser devices that are vertically stacked with respect to an installation surface, and the plurality of laser devices may constitute a plurality of transmission channels that are vertically stacked.

In the LIDAR device according to an aspect of the present disclosure, the plurality of laser devices may constitute a transmission channel of 4 vertical channels or 8 vertical channels.

In the LIDAR device according to an aspect of the present disclosure, the laser device may be an edge emitting laser diode.

In the LIDAR device according to an aspect of the present disclosure, the optical receiver may include a plurality of detectors that are vertically stacked with respect to an installation surface, and the plurality of detectors may constitute a plurality of reception channels that are vertically stacked.

In the LIDAR device according to an aspect of the present disclosure, the detector may be a single-photon avalanche diode (SPAD).

In the LIDAR device according to an aspect of the present disclosure, the plurality of detectors may be arranged in a two-dimensional array consisting of X (X is a natural number of 2 or more) rows and Y (Y is a natural number of 2 or more) columns.

In the LIDAR device according to an aspect of the present disclosure, the X rows may be arranged such that vertical viewing angles are aligned to correspond to the plurality of transmission channels, and only some of the Y columns may be arranged to receive the laser light such that detectors that are arranged in columns to receive the laser light constitute a plurality of reception channels corresponding to the plurality of transmission channels.

In the LIDAR device according to an aspect of the present disclosure, among the Y columns of the two-dimensional array, detectors that are disposed in columns not receiving the laser light may be set to an off state.

In the LIDAR device according to an aspect of the present disclosure, the detector may be set to an on state only when receiving the laser light.

According to another aspect of the present disclosure, provided is a LIDAR device, including an optical transmitter comprising a plurality of laser devices that constitute a plurality of transmission channels for transmitting laser light for detecting an external object in an assigned transmission time slot; an optical receiver which is disposed to be spaced apart from one side of the optical transmitter and comprises a plurality of detectors that constitute a plurality of reception channels for receiving laser light that is reflected by the external object in a reception time slot allocated to correspond to the transmission time slot; a scanner which is disposed between the optical transmitter and the optical receiver, reflects laser light that is transmitted by the optical transmitter to the outside, and reflects laser light that is reflected from the external object and returned to the optical receiver; and a signal processor for sequentially processing laser light that is received by the optical receiver according to the order of the reception time slot.

In the LIDAR device according to an aspect of the present disclosure, N (N is a natural number) number of the reception channels may be assigned to each reception time slot.

In the LIDAR device according to an aspect of the present disclosure, the signal processor may have N signal processing channels that are assigned in a one-to-one correspondence with the N number of reception channels per reception time slot.

In the LIDAR device according to another aspect of the present disclosure, the plurality of transmission channels may be vertically stacked and arranged with respect to an installation surface.

In the LIDAR device according to another aspect of the present disclosure, the laser device may be an edge emitting laser diode.

In the LIDAR device according to another aspect of the present disclosure, the plurality of reception channels may be vertically stacked and arranged with respect to an installation surface.

In the LIDAR device according to another aspect of the present disclosure, the detector may be a single-photon avalanche diode (SPAD).

In the LIDAR device according to another aspect of the present disclosure, the plurality of detectors may be arranged in a two-dimensional array consisting of X (X is a natural number of 2 or more) rows and Y (Y is a natural number of 2 or more) columns.

In the LIDAR device according to another aspect of the present disclosure, the X rows may be arranged such that vertical viewing angles are aligned to correspond to the plurality of transmission channels, and only some of the Y columns may be arranged to receive the laser light such that detectors that are arranged in columns to receive the laser light constitute a plurality of reception channels corresponding to the plurality of transmission channels.

In the LIDAR device according to another aspect of the present disclosure, among the Y columns of the 2D array, detectors that are disposed in columns not receiving the laser light may be set to an off state.

In the LIDAR device according to another aspect of the present disclosure, the detector may be set to an on state only when receiving the laser light.

In the LIDAR device according to another aspect of the present disclosure, the signal processor may determine the intensity of a signal based on the frequency of laser light that is received and processed by the detector.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a configuration diagram of a LIDAR device according to an exemplary embodiment of the present disclosure.

FIG. 2 is a diagram showing the detailed configuration of an optical transmitter of the LIDAR device according to an exemplary embodiment of the present disclosure.

FIG. 3 is a diagram showing the detailed configuration of an optical receiver of the LIDAR device according to an exemplary embodiment of the present disclosure.

FIG. 4 is a diagram exemplarily showing the configuration of a reception channel of an optical sensor of the optical receiver of the LIDAR device according to an exemplary embodiment of the present disclosure.

FIG. 5 is a diagram exemplarily showing the configuration and operation of a transmission channel, a reception channel and a signal processing channel of the LIDAR device according to an exemplary embodiment of the present disclosure.

FIG. 6 is a diagram showing another example of the configuration and operation of a transmission channel, a reception channel and a signal processing channel of the LIDAR device according to an exemplary embodiment of the present disclosure.

FIG. 7 is a view showing a modified example of a mirror of a scanner of the LIDAR device according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

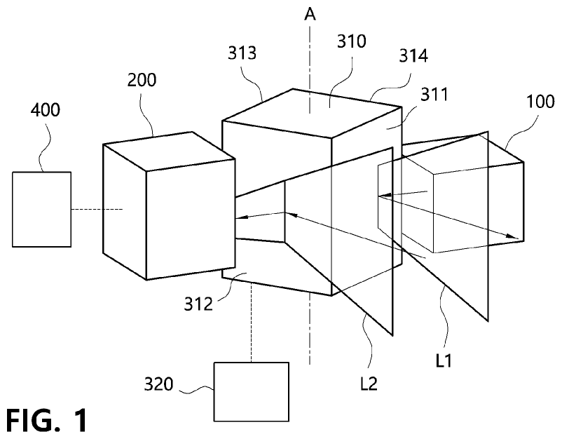

FIG. 1 is a configuration diagram of a LIDAR device according to an exemplary embodiment of the present disclosure.

The LIDAR device according to an exemplary embodiment of the present disclosure has a structure that can lower the height compared to the conventional LIDAR device. Accordingly, when the LIDAR device according to an exemplary embodiment of the present disclosure is installed in a vehicle or the like, it provides a high degree of freedom in selecting a mounting position.

In addition, the LIDAR device according to an exemplary embodiment of the present disclosure enables the high-output design of a light source to be easily and efficiently achieved. More specifically, in the LIDAR device according to an exemplary embodiment of the present disclosure, the laser device 111 of the light source 110 of the optical transmitter 100 and the detector 221 of the optical sensor 220 of the optical receiver 200 may reduce the difficulty of a high-output design.

Referring to FIG. 1, the LIDAR device according to an exemplary embodiment of the present disclosure includes an optical transmitter 100, an optical receiver 200, a scanner 300 and a signal processor 400. The laser light L1 transmitted from the optical transmitter 100 is reflected by the scanner 300 and travels to the outside, and the laser light L2 reflected by an external object and returned is reflected by the scanner 300 and the optical receiver 200 to proceed. The laser light L2 received by the optical receiver 200 may be processed by the signal processor 400.

Hereinafter, the configurations of the LIDAR device according to an exemplary embodiment of the present disclosure, that is, the optical transmitter 100, the optical receiver 200, the scanner 300 and the signal processor 400 will be described in detail.

The optical transmitter 100 transmits laser light L1 for detecting an external object (not illustrated). For example, the optical transmitter 100 may have a divergence angle specification in the form of a line beam. That is, the laser light L1 transmitted by the optical transmitter 100 may have a line beam shape.

The laser light L1 transmitted from the optical transmitter 100 is reflected by the scanner 300 and transmitted to the outside. In addition, the laser light L2 reflected by the external object and returned may be reflected by the scanner 300 and proceed to the optical receiver 200.

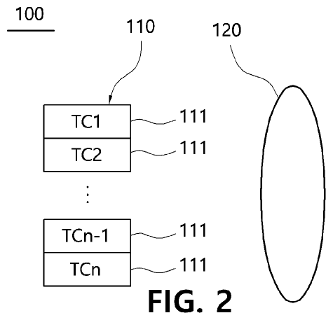

FIG. 2 is a diagram showing the detailed configuration of an optical transmitter of the LIDAR device according to an exemplary embodiment of the present disclosure. Referring to FIG. 2, the optical transmitter 100 may include a light source 110 and a transmission optical system 120.

The light source 110 generates laser light L1 for detecting the external object and transmits the same to the outside. The light source 110 may include a plurality of laser devices 111. More specifically, the light source 110 may include a plurality of laser devices 11I that are vertically stacked with respect to an installation surface.

The plurality of laser devices 111 may constitute a plurality of vertically stacked transmission channels TC1, TC2, . . . TCn−1, TCn (n is a natural number of 2 or more). For example, the plurality of laser devices 111 may constitute a transmission channel of 4 vertical channels or 8 vertical channels. Certainly, this is just exemplary, and the number of vertical channels constituted by the plurality of laser devices 111 may be increased or decreased according to the required output, detection range and the like.

In an exemplary embodiment of the present disclosure, the plurality of transmission channels TC1, TC2, . . . TCn−1, TCn may transmit laser light for detecting the external object in an allocated transmission time slot. In other words, each of the plurality of transmission channels TC1, TC2, . . . TCn−1, TCn may transmit laser light in transmission time slots that are allocated thereto.

In this case, the interval between the laser beams transmitted by the plurality of transmission channels TC1, TC2, . . . TCn−1, TCn and the horizontal axis may be formed to be constant or not constant. In addition, the vertical divergence angle of each transmission channel may be set to an angle that is smaller than or equal to the vertical resolution as required by the LIDAR device.

The laser device 111 may be an edge emitting laser diode. Edge emitting laser diodes have a feature that can implement a high output with a small number compared to vertical-cavity surface-emitting lasers (VCSEL). In order to implement a high output by using vertical-cavity surface-emitting lasers (VCSEL), it is necessary to arrange tens to hundreds of channels along a vertical axis, and it is not easy to allocate and drive addresses. In comparison, edge emitting laser diodes can implement a high output with a relatively small number of devices, and can relatively easily achieve the addressable driving of a plurality of transmission channels. Therefore, when the laser device 111 of the light source 110 is constituted of an edge-emitting laser diode, the high-output design and the efficiency and easiness of driving of the light source 110 may be increased.

The transmission optical system 120 guides the propagation of laser light that is irradiated by the plurality of transmission channels TC1, TC2, . . . TCn−1, TCn. More specifically, the transmission optical system 120 may be disposed on a transmission path of the laser light transmitted from the light source 110 such that an angle formed by the laser light and a horizontal axis on the transmission path may be formed differently for each transmission channel. That is, the transmission optical system 120 may differently steer the angle formed by the traveling direction of the transmitted laser light source with the horizontal axis for each transmission channel. For example, the transmission optical system 120 may form an angle between the plurality of laser transmission channels TC1, TC2, . . . TCn−1, TCn and the horizontal axis in the range of −10° to 10°.

The transmission optical system 120 may include a lens. For example, the lens may be a cylindrical lens, an acylindrical lens, a spherical lens or an aspherical lens. In addition, the transmission optical system 120 may include a micro lens array.

The optical receiver 200 receives the laser light L2 that is reflected by the external object. In an exemplary embodiment of the present disclosure, the optical receiver 200 is disposed to be spaced apart from one side of the optical transmitter 100. The optical receiver 200 is disposed to be stacked with the optical transmitter 100 or side surfaces are not disposed in contact with each other. That is, the optical receiver 200 may be disposed side by side with the optical transmitter 100 at a predetermined distance apart from each other on an installation surface. In addition, the laser light L2 transmitted from the optical transmitter 100 to the outside and reflected by the external object and returned may be reflected by the scanner 300 and incident to the optical receiver 200.

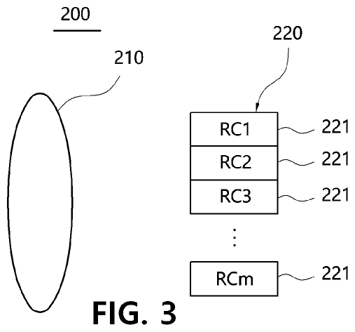

FIG. 3 is a diagram showing the detailed configuration of an optical receiver of the LIDAR device according to an exemplary embodiment of the present disclosure. Referring to FIG. 3, an optical receiver 200 may include a reception optical system 210 and an optical sensor 220.

The reception optical system 210 is disposed on a receiving path for receiving the laser light L2 that is reflected from the external object and returned, and guides the laser light L2 toward the optical sensor 220. As will be described below, the optical sensor 220 may include a plurality of detectors 221 that are vertically stacked with respect to an installation surface, and the plurality of detectors 221 may constitute a plurality of reception channels RC1, RC2, . . . RCm that are vertically stacked. In this case, the reception optical system 210 may form different steering angles of the plurality of reception channels RC1, RC2, . . . RCm for each reception channel.

The reception optical system 210 may include any one or more of a lens and a micro lens array. For example, the lens may be a cylindrical lens, an acylindrical lens, a spherical lens or an aspherical lens.

The optical sensor 220 receives laser light that is incident through the reception optical system 210. The optical sensor 220 may include a plurality of detectors 221. More specifically, the optical sensor 220 may include a plurality of detectors 221 that are vertically stacked on the installation surface.

The plurality of detectors 221 may constitute a plurality of reception channels RC1, RC2, . . . RCm (m is a natural number of 2 or more) that are vertically stacked. Each of the plurality of reception channels RC1, RC2, . . . RCm may receive laser light with its own steering angle. A plurality of reception channels RC1, RC2, . . . RCm may have respective steering angles without overlapping with each other.

The plurality of reception channels RC1, RC2, . . . RCm respectively receive the laser light emitted from the optical transmitter 100 and reflected by the scanner 300 after being reflected by an external object and returned. In an exemplary embodiment of the present disclosure, the plurality of reception channels RC1, RC2, . . . RCm may receive the laser light that is reflected by the external object in a reception time slot allocated to correspond to the transmission time slot. In other words, each of the plurality of reception channels RC1, RC2, . . . RCm may receive the laser light in the reception time slot allocated thereto.

N (N is a natural number) number of the reception channels may be assigned to each reception time slot. The number of reception channels may be the same as or different from the number of transmission channels. For example, when the number of transmission channels is greater than the number of reception channels (e.g., n is 8, and m is 4), one reception channel covers a relatively wide vertical area, and two or more transmission channels may be arranged to correspond to a vertical area that is covered by one reception channel. Meanwhile, as the number of the reception channels increases, one reception channel covers a relatively narrow vertical area. It may also be considered that the reception channel corresponds to the transmission channel one-to-one or two or more reception channels correspond to one transmission channel.

The detector 221 may be a single-photon avalanche diode (SPAD). In this case, the plurality of detectors 221 may be arranged in a one-dimensional or two-dimensional array. For example, it may be arranged in a two-dimensional array consisting of X (X is a natural number of 2 or more) rows and Y (Y is a natural number of 2 or more) columns. Meanwhile, the performance of the minimum detection distance of the LIDAR device may be secured by adjusting the start time of the incident light signal of the detector 221 composed of SPAD.

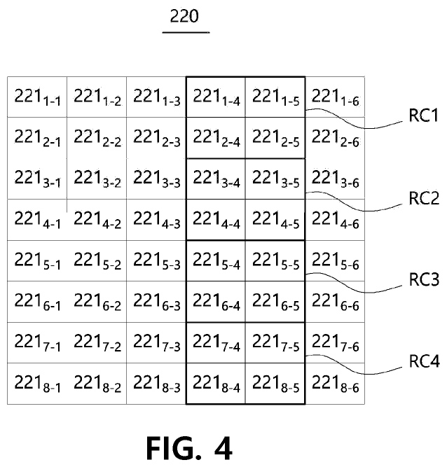

FIG. 4 is a diagram exemplarily showing the configuration of a reception channel of an optical sensor of the optical receiver of the LIDAR device according to an exemplary embodiment of the present disclosure.

Referring to FIG. 4, a plurality of detectors 221 are arranged in a two-dimensional array consisting of 8 rows and 6 columns. Assuming that 4 reception channels in the optical sensor 220 cover a plurality of transmission channels, 8 rows are arranged such that vertical viewing angles correspond to the plurality of transmission channels, and 6 columns are arranged such that only some thereof receive the laser light, and thus, detectors 221₁₋₄, 221₁₋₅, 221₂₋₄, 221₂₋₅, 221₃₋₄, 221₃₋₅, 221₄₋₄, 221₄₋₅, 221₅₋₄, 221₅₋₅, 221₆₋₄, 221₆₋₅, 221₇₋₄, 221₇₋₅, 221₈₋₄, 221₈₋₅ that are disposed in the columns receiving the laser light may constitute four reception channels corresponding to the plurality of transmission channels.

More specifically, the detectors 221₁₋₄, 221₁₋₅, 221₂₋₄, 221₂₋₅ that are arranged in columns 4 and 5 of row 1 and columns 4 and 5 of row 2 constitute a first reception channel RC1, the detectors 221₃₋₄, 221₃₋₅, 221₄₋₄, 221₄₋₅ that are arranged in columns 4 and 5 of row 3 and columns 4 and 5 of row 4 constitute a second reception channel RC2, the detectors 221₅₋₄, 221₅₋₅, 221₆₋₄, 221₆₋₅ that are arranged in columns 4 and 5 of row 5 and columns 4 and 5 of row 6 constitute a third reception channel RC3, and the detectors 221₇₋₄, 221₇₋₅, 221₈₋₄, 221₈₋₅ that are arranged in columns 4 and 5 of row 7 and columns 4 and 5 of row 8 constitute a fourth reception channel RC4.

In this way, when detectors are composed of SPADs and a plurality of detectors are arranged in a two-dimensional array consisting of X (X is a natural number of 2 or more) rows and Y (Y is a natural number of 2 or more) columns, by arranging only the focal length and vertical viewing angle (range) of the detectors composed of SPADs, it is possible to easily configure a plurality of reception channels that are vertically arranged. Accordingly, difficulty in aligning the optical sensor 220 may be lowered, and productivity may be improved.

Meanwhile, among the six columns of the two-dimensional array, detectors 221₁₋₁, 221₁₋₂, 221₁₋₃, 221₁₋₆, 221₂₋₁, 221₂₋₂, 221₂₋₃, 221₂₋₆, 221₃₋₁, 221₃₋₂, 221₃₋₃, 221₃₋₆, 221₄₋₁, 221₄₋₂, 221₄₋₃, 221₄₋₆, 221₅₋₁, 221₅₋₂, 221₅₋₃, 221₅₋₆, 221₆₋₁, 221₆₋₂, 221₆₋₃, 221₆₋₆, 221₇₋₁, 221₇₋₂, 221₇₋₃, 221₇₋₆, 221₈₋₁, 221₈₋₂, 221₈₋₃, 221₈₋₆ that are arranged in columns not receiving the laser light may be set to an off state. In this way, the detectors that are disposed in the columns that do not receive the laser light among the Y columns of the two-dimensional array, that is, the channels from which the signal laser light is not acquired may be set to an off state, thereby reducing the power consumption of the LIDAR device.

Furthermore, the detectors 221₁₋₄, 221₁₋₅, 221₂₋₄, 221₂₋₅ that are arranged in columns 4 and 5 of row 1 and columns 4 and 5 of row 2 constituting the first reception channel RC1, the detectors 221₃₋₄, 221₃₋₅, 221₄₋₄, 221₄₋₅ that are arranged in columns 4 and 5 of row 3 and columns 4 and 5 of row 4 constituting the second reception channel 2 RC2, the detectors 221₅₋₄, 221₅₋₅, 221₆₋₄, 221₆₋₅ that are arranged in columns 4 and 5 of row 5 and columns 4 and 5 of row 6 constituting the third reception channel RC3, and the detectors 221₇₋₄, 221₇₋₅, 221₈₋₄, 221₈₋₅ that are arranged in columns 4 and 5 of row 7 and columns 4 and 5 of row 8 constituting the fourth reception channel RC4 may be set to an on state only when receiving the laser light. In other words, the plurality of detectors may be set to an on state only when receiving the laser light.

When a plurality of vertically arranged reception channels are turned on at the same time, crosstalk due to reflection or the like may occur. However, if only the detectors arranged in the reception channels that receive the laser light are sequentially turned on, since the torque is generated only within the on-state reception channel, crosstalk may be prevented from occurring throughout the optical receiver 200. For example, when a plurality of reception channels are vertically stacked into 4 channels, time difference on/off control may be performed by dividing the vertical channels into 4 equal parts. In addition, when a plurality of reception channels are vertically stacked in 8 channels, time difference on/off control may be performed by dividing the vertical channels into 8 equal parts.

The scanner 300 is disposed between the optical transmitter 100 and the optical receiver 200. That is, the optical transmitter 100 may be disposed on one side of the scanner 300, and the optical receiver 200 may be disposed on the other side of the scanner 300.

The scanner 300 reflects the laser light L1 transmitted from the optical transmitter 100 to the outside, and reflects the laser light L2 that is reflected from the external object and returned to the optical receiver 200. The scanner 300 emits the laser light transmitted from the optical transmitter 100 in a horizontal direction, and propagates the laser light that is emitted in the horizontal direction and then reflected by the external object and returned to the optical receiver 200.

In an exemplary embodiment of the present disclosure, the scanner 300 may include a mirror 310 and an actuator 320.

The mirror 310 has a plurality of reflective surfaces. The number, shape and arrangement of the reflective surfaces of the mirror 310 may be designed in various ways as necessary. The reflective surfaces of the mirror 310 may be configured by bonding a reflector to the mirror body, or may be configured by coating a reflector on the mirror body. When the reflecting surface of the mirror 310 is configured in the form of a coating, the weight of the scanner 300 may be reduced.

The mirror 310 rotates around a rotation axis A. The rotation axis A may be disposed perpendicular to an installation surface. In addition, as the mirror 310 rotates around the rotation axis A, the plurality of reflective surfaces may rotate around the rotation axis A.

In an exemplary embodiment of the present disclosure, the optical transmitter 100 and the optical receiver 200 are not stacked, but are spaced apart and arranged side by side with the scanner 300 interposed therebetween. Accordingly, the mirror 310 of the scanner 300 does not need to separately include a transmission mirror and a reception mirror. In other words, the plurality of reflective surfaces of the mirror 310 rotate around the rotational axis A and function as transmission mirrors (mirrors that reflect laser light transmitted from the optical transmitter 100 to the outside) depending on the positions thereof, or function as reception mirrors (mirrors that reflect laser light reflected from an external object and returned to the optical receiver 200).

Accordingly, the scanner of the LIDAR device according to the present disclosure may reduce the number of parts, size, weight and the like of the mirror 310 compared to the conventional scanner in which transmission mirrors and reception mirrors are stacked. In addition, the load of the actuator 320 rotating the mirror 310 may be reduced. As a result, the scanner 300 can be made smaller and lighter, and the power consumption of the scanner 300 can be reduced.

In an exemplary embodiment of the present disclosure, the mirror 310 has four reflective surfaces 311, 312, 313, 314. In this case, each of the four reflective surfaces 311, 312, 313, 314 may have a rectangular shape having the same size.

The actuator 320 rotates the mirror 310 such that the plurality of reflective surfaces 311, 312, 313, 314 rotate about the rotation axis A. The actuator 320 may be embedded inside the mirror 310. For example, actuator 320 may be a motor. More specifically, the actuator 320 may be a BLDC motor, an outer rotor motor or the like.

Meanwhile, in an exemplary embodiment of the present disclosure, an encoder may be applied to the scanner 300. For example, by applying an encoder to the scanner 300, signals may be generated at each specific angle (position) of the mirror 310 such that constant signals can be generated regardless of the constant speed rotation of the actuator 320.

The signal processor 400 sequentially processes the laser light received by the optical receiver 200 according to the order of the reception time slot. The signal processor 400 detects laser light as a signal such that the distance to the external object can be calculated. For example, distance extraction may be performed by devices such as FPGA, MCU, TDC and the like.

Assuming that N (N is a natural number) reception channels are allocated per reception time slot, the signal processor 400 may have N signal processing channels that are assigned in a one-to-one correspondence with the N reception channels. For example, when 4 reception channels are assigned to each reception time slot, 4 signal processors 400 may have 4 signal processing channels.

The signal processor 400 may determine the intensity of a signal based on the frequency of laser light received and processed by the detector 221. In an exemplary embodiment of the present disclosure, when the plurality of detectors 221 are configured as SPADs, the detectors 221 operate in Geiger mode. Therefore, when using an analog-to-digital converter (ADC), there may be a limitation in obtaining intensity information with only one signal (1 shot). However, if the signal processor 400 checks the frequency of the laser light received and processed by the detector 221, that is, the intensity through the mode of an optical signal based on the accumulation, it is possible to overcome the problem of the ADC method.

For example, the signal processor 400 may detect a signal related to the distance calculation by using a time-to-digital converter (TDC) method. In this case, as the distance extraction method, the method of amplifying an incident signal and measuring a time exceeding a threshold voltage may be used. The TDC method has the advantage of being able to detect signals at a relatively high signal-to-noise ratio (SNR) compared to the analog-to-digital converter (ADC) method.

Hereinafter, the concept of configuring and operating a transmission channel and a reception channel of the LIDAR device according to an exemplary embodiment of the present disclosure will be described.

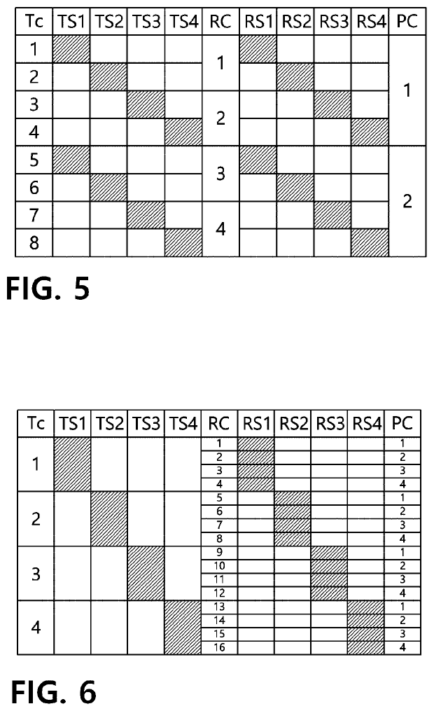

FIG. 5 is a diagram exemplarily showing the configuration and operation of a transmission channel, a reception channel and a signal processing channel of the LIDAR device according to an exemplary embodiment of the present disclosure.

Referring to FIG. 5, the optical transmitter 100 is provided with eight transmission channels TC1, TC2, TC3, TC4, TC5, TC6, TC7, TC8. The laser device constituting each transmission channel may be an edge emitting laser diode. The optical receiver 200 is provided with 4 reception channels RC1, RC2, RC3, RC4. The 4 reception channels RC1, RC2, RC3, RC4 may oriented and disposed by dividing the vertical reception range corresponding to the vertical transmission range covered by the 8 transmission channels TC1, TC2, TC3, TC4, TC5, TC6, TC7, TC8. As described above, this directivity may be formed by the transmission optical system 120 and the reception optical system 210.

Four transmission time slots TS1, TS2, TS3, TS4 and four reception time slots RS1, RS2, RS3, RS4 are assigned to scan the vertical scan range once, respectively. In this case, one transmission time slot and one reception time slot may each be set to several μs (e.g., 2 to 3 μs). Certainly, this is just exemplary, and one transmission time slot and one reception time slot, horizontal scan time and the like may be changed according to the detection distance and horizontal range.

In the first transmission time slot TS1, the first transmission channel TC1 and the fifth transmission channel TC5 transmit laser light, and the reflected and returned laser light is received by the first reception channel RC1 and the third reception channel RC3 in the first reception time slot RS1. The second transmission channel TC2 and the sixth transmission channel TC6 transmit laser light in the second transmission time slot TS2, and the reflected and returned laser light is received by the first reception channel RC1 and the third reception channel RC3 in the second reception time slot RS2. In the third transmission time slot TS3, the third transmission channel TC3 and the seventh transmission channel TC7 transmit laser light, and the reflected and returned laser light is received by the second reception channel RC2 and the fourth reception channel RC4 in the third reception time slot RS3. In the fourth transmission time slot TS4, the fourth transmission channel TC4 and the eighth transmission channel TC8 transmit the laser light, and the reflected and returned laser light is received by the second reception channel RC2 and the fourth reception channel RC4 in the fourth reception time slot RS4.

Meanwhile, the signal processor 400 is disposed with two signal processing channels PC1, PC2. The first signal processing channel PC1 of the signal processor 400 processes laser light received by the first reception channel RC1 and the second reception channel RC2. The second signal processing channel PC2 of the signal processor 400 processes laser light received by the third reception channel RC3 and the fourth reception channel RC4. As described above, it can be said that it is optimal when considering the efficiency of signal processing that the number of signal processing channels of the signal processor 400 is provided to be equal to the number of reception channels that are assigned to each reception time slot.

As shown in FIG. 5, when the LIDAR device is configured and operated, laser light is received in two reception channels that are not adjacent to each other among four reception channels in one reception time slot. Accordingly, only detectors that are arranged in two reception channels that are not adjacent to each other may be set to an on state, and detectors that are arranged in the other reception channels may be set to an off state. Accordingly, crosstalk can be reduced compared to cases where laser light is simultaneously received in the channels that are adjacent to each other.

FIG. 6 is a diagram showing another example of the configuration and operation of a transmission channel, a reception channel and a signal processing channel of the LIDAR device according to an exemplary embodiment of the present disclosure. In order to configure reception channels as shown in FIG. 6, a plurality of detectors 221 included in the optical sensor 220 may be arranged to form a two-dimensional array having 16 or more rows. As described above, the detector 221 may be a single-photon avalanche diode (SPAD).

Referring to FIG. 6, the optical transmitter 100 is provided with four transmission channels TC1, TC2, TC3, TC4. Laser devices constituting each transmission channel may be edge emitting laser diodes. The optical receiver 200 is provided with 16 reception channels RC1, RC2, RC3, RC4, RC5, RC6, RC7, RC8, RC9, RC10, RC11, RC12, RC13, RC14, RC15, RC16. The 16 reception channels RC1, RC2, RC3, RC4, RC5, RC6, RC7, RC8, RC9, RC10, RC11, RC12, RC13, RC14, RC15, RC16 may be oriented and disposed by dividing the vertical reception range corresponding to the vertical transmission range covered by the 4 transmission channels TC1, TC2, TC3, TC4. As described above, this directivity may be formed by the transmission optical system 120 and the reception optical system 210.

Four transmission time slots TS1, TS2, TS3, TS4 and four reception time slots RS1, RS2, RS3, RS4 are assigned to scan the vertical scan range once, respectively. In this case, one transmission time slot and one reception time slot may each be set to several μs (e.g., 2 to 3 μs). Certainly, this is just exemplary, and one transmission time slot and one reception time slot, horizontal scan time and the like may be changed according to the detection distance and horizontal range.

In the first transmission time slot TS1, the first transmission channel TC1 transmits laser light, and the laser light that is reflected by an external object and returned is received by the first to fourth reception channels RC1, RC2, RC3, RC4 in the first reception time slot RS1. In the second transmission time slot TS2, the second transmission channel TC2 transmits laser light, and the laser light that is reflected by an external object and returned is received by the fifth to eighth reception channels RC5, RC6, RC7, RC8 in the second reception time slot RS2. In the third transmission time slot TS3, the third transmission channel TC3 transmits laser light, and the laser light that is reflected by an external object and returned is received by the ninth to twelfth reception channels RC9, RC10, RC11, RC12 in the third reception time slot RS3. In the fourth transmission time slot TS4, the fourth transmission channel TC4 transmits laser light, and the laser light that is reflected by an external object and returned is received by the thirteenth to sixteenth reception channels RC13, RC14, RC715 RC16 in the fourth reception time slot RS4.

Meanwhile, the signal processor 400 is disposed with four signal processing channels PC1, PC2, PC3, PC4. In the example shown in FIG. 6, since the four signal processing channels PC1, PC2, PC3, PC4 are arranged in one-to-one correspondence with different reception channels for each reception time slot RS1, RS2, RS3, RS4, the 4 signal processing channels PC1, PC2, PC3, PC4 are described to be overlapped by the number of reception time slots. Processing of the received laser light by the four signal processing channels PC1, PC2, PC3, PC4 may be performed as follows.

In the first reception time slot RS1, the laser light that is received by the first to fourth reception channels RC1, RC2, RC3, RC4 is processed in one-to-one correspondence with four signal processing channels PC1, PC2, PC3, PC4. More specifically, the laser light received by the first reception channel RC1 may be processed by the first signal processing channel PC1, the laser light received by the second reception channel RC2 may be processed by the second signal processing channel PC2, the laser light received by the third reception channel RC3 may be processed by the third signal processing channel PC3, and the laser light received by the fourth reception channel RC4 may be processed by the fourth signal processing channel PC4.

Further, in the second reception time slot RS2, the laser light that is received by the fifth to eighth reception channels RC5, RC6, RC7, RC8 is processed in one-to-one correspondence with four signal processing channels PC1, PC2, PC3, PC4. More specifically, in the second reception time slot RS2, the laser light received by the fifth reception channel RC5 may be processed by the first signal processing channel PC1, the laser light received by the sixth reception channel RC6 may be processed by the second signal processing channel PC2, the laser light received by the seventh reception channel RC7 may be processed by the third signal processing channel PC3, and the laser light received by the eighth reception channel RC8 may be processed by the fourth signal processing channel PC4.

Further, in the third reception time slot RS3, the laser light that is received by the ninth to twelfth reception channels RC9, RC10, RC11, RC12 is processed in one-to-one correspondence with four signal processing channels PC1, PC2, PC3, PC4. More specifically, in the third reception time slot RS3, the laser light received by the ninth reception channel RC9 may be processed by the first signal processing channel PC1, the laser light received by the tenth reception channel RC10 may be processed by the second signal processing channel PC2, the laser light received by the eleventh reception channel RC11 may be processed by the third signal processing channel PC3, and the laser light received by the twelfth reception channel RC12 may be processed by the fourth signal processing channel PC4.

Further, in the fourth reception time slot RS4, the laser light that is received by the thirteenth to sixteenth reception channels RC13, RC14, RC15, RC16 is processed in one-to-one correspondence with four signal processing channels PC1, PC2, PC3, PC4. More specifically, in the fourth reception time slot RS4, the laser light received by the thirteenth reception channel RC13 may be processed by the first signal processing channel PC1, the laser light received by the fourteenth reception channel RC14 may be processed by the second signal processing channel PC2, the laser light received by the fifteenth reception channel RC15 may be processed by the third signal processing channel PC3, and the laser light received by the sixteenth reception channel RC16 may be processed by the fourth signal processing channel PC4.

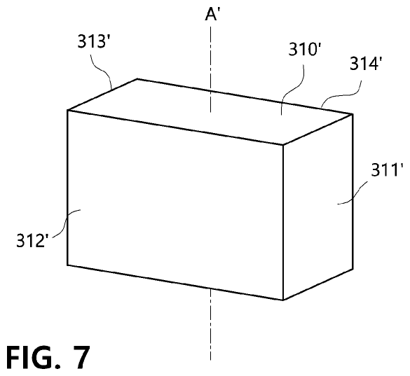

FIG. 7 is a view showing a modified example of a mirror of a scanner of the LIDAR device according to an exemplary embodiment of the present disclosure.

Referring to FIG. 7, two adjacent reflective surfaces among a plurality of reflective surfaces of the mirror 310′ may have a rectangular shape having different widths. More specifically, the mirror 310′ may have four reflective surfaces 311′, 312′, 313′, 314′, and the reflective surfaces adjacent to each other may have different widths.

The shape of the mirror of the scanner 300 is related to the frame rate of the scanner 300 and the LIDAR device. Considering the frame rate of the scanner 300 and the LIDAR device, if necessary, the mirror 310′ may have a plurality of reflective surfaces as in the modified example, but the adjacent reflective surfaces may be configured to have a rectangular shape with different widths.

In the above, the LIDAR device according to an exemplary embodiment of the present disclosure has been described in detail. The LIDAR device according to an exemplary embodiment of the present disclosure has a structure in which the optical transmitter 100 and the optical receiver 200 are disposed to be spaced apart from each other side by side with the scanner 300 interposed therebetween. This structure reduces the height of the LIDAR device compared to conventional LIDAR devices in which an optical transmitter and an optical receiver are stacked and arranged, and correspondingly, a scanner also adopts a structure in which a transmission mirror and a reception mirror are stacked. Therefore, the high degree of freedom may be provided in selecting the mounting location of the LIDAR device.

In addition, the optical entrance of the optical receiver 200 may be increased through the left-right arrangement of the optical transmitter 100 and the optical receiver 200. An increase in the optical entrance of the optical receiver 200 may be connected to an increase in the detection distance of the LIDAR device.

The LIDAR device according to the present disclosure can reduce the height of the LIDAR device and provide a high degree of freedom in the selection of the mounting position through a configuration in which the optical transmitter and the optical receiver are disposed to be spaced apart with the scanner interposed therebetween.

The LIDAR device according to the present disclosure can provide ease and efficiency in high-power design through a combination of the edge emitting laser diode of an optical transmitter and the single-photon avalanche diode (SPAD) of an optical receiver.

It should be understood that the effects of the present disclosure are not limited to the above-described effects and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A LIDAR device, comprising:
an optical transmitter for transmitting laser light for detecting an external object;
an optical receiver which is disposed to be spaced apart from one side of the optical transmitter and receives laser light that is reflected by the external object; and
a scanner which is disposed between the optical transmitter and the optical receiver, reflects laser light that is transmitted by the optical transmitter to the outside, and reflects laser light that is reflected from the external object and returned to the optical receiver.

2. The LIDAR device of claim 1, wherein the scanner comprises a mirror having a plurality of reflective surfaces and an actuator for rotating the mirror such that the plurality of reflective surfaces rotate about a rotation axis.

3. The LIDAR device of claim 2, wherein each of the plurality of reflective surfaces has a rectangular shape having the same size.

4. The LIDAR device of claim 2, wherein two adjacent reflective surfaces among the plurality of reflective surfaces have a rectangular shape with different widths.

5. The LIDAR device of claim 1, wherein the optical transmitter comprises a plurality of laser devices that are vertically stacked with respect to an installation surface, and the plurality of laser devices constitute a plurality of transmission channels that are vertically stacked.

6. The LIDAR device of claim 5, wherein the laser device is an edge emitting laser diode.

7. The LIDAR device of claim 5, wherein the optical receiver comprises a plurality of detectors that are vertically stacked with respect to an installation surface, and the plurality of detectors constitute a plurality of reception channels that are vertically stacked.

8. The LIDAR device of claim 7, wherein the detector is a single-photon avalanche diode (SPAD).

9. The LIDAR device of claim 8, wherein the plurality of detectors are arranged in a two-dimensional array consisting of X (X is a natural number of 2 or more) rows and Y (Y is a natural number of 2 or more) columns.

10. The LIDAR device of claim 9, wherein the X rows are arranged such that vertical viewing angles are aligned to correspond to the plurality of transmission channels, and only some of the Y columns are arranged to receive the laser light such that detectors that are arranged in columns to receive the laser light constitute a plurality of reception channels corresponding to the plurality of transmission channels.

11. The LIDAR device of claim 10, wherein among the Y columns of the two-dimensional array, detectors that are disposed in columns not receiving the laser light are set to an off state.

12. The LIDAR device of claim 8, wherein the detector is set to an on state only when receiving the laser light.

13. A LIDAR device, comprising:
an optical transmitter comprising a plurality of laser devices that constitute a plurality of transmission channels for transmitting laser light for detecting an external object in an assigned transmission time slot;
an optical receiver which is disposed to be spaced apart from one side of the optical transmitter and comprises a plurality of detectors that constitute a plurality of reception channels for receiving laser light that is reflected by the external object in a reception time slot allocated to correspond to the transmission time slot;
a scanner which is disposed between the optical transmitter and the optical receiver, reflects laser light that is transmitted by the optical transmitter to the outside, and reflects laser light that is reflected from the external object and returned to the optical receiver; and
a signal processor for sequentially processing laser light that is received by the optical receiver according to the order of the reception time slot.

14. The LIDAR device of claim 13, wherein the plurality of transmission channels are vertically stacked and arranged with respect to an installation surface.

15. The LIDAR device of claim 14, wherein the laser device is an edge emitting laser diode.

16. The LIDAR device of claim 14, wherein the plurality of reception channels are vertically stacked and arranged with respect to an installation surface.

17. The LIDAR device of claim 16, wherein the detector is a single-photon avalanche diode (SPAD).

18. The LIDAR device of claim 17, wherein the plurality of detectors are arranged in a two-dimensional array consisting of X (X is a natural number of 2 or more) rows and Y (Y is a natural number of 2 or more) columns.

19. The LIDAR device of claim 18, wherein the X rows are arranged such that vertical viewing angles are aligned to correspond to the plurality of transmission channels, and only some of the Y columns are arranged to receive the laser light such that detectors that are arranged in columns to receive the laser light constitute a plurality of reception channels corresponding to the plurality of transmission channels.

20. The LIDAR device of claim 17, wherein the signal processor determines the intensity of a signal based on the frequency of laser light that is received and processed by the detector.
